(19) United States
(12) Patent Application Publication
(10) Pub. No.: US 2017/0159577 A1
(43) Pub. Date: Jun. 8, 2017

(54) Gas Turbine Combined Electric Power Generation Apparatus

(71) Applicant: Hitachi, Ltd., Chiyoda-ku, Tokyo (JP)

(72) Inventors: Noriaki HINO, Tokyo (JP); Aung Ko THET, Tokyo (JP); Naohiro KUSUMI, Tokyo (JP)

(21) Appl. No.: 15/309,598

(22) PCT Filed: May 30, 2014
(86) PCT No.: PCT/JP2014/064364

§ 371 Date: Nov. 8, 2016

(51) Int. Cl. F02C 9/54; F02C 7/042; H02K 7/18; F02C 6/14; F04D 29/56; F02C 3/04; F01D 15/10

(52) U.S. Cl. CPC F02C 9/54; F02C 3/04; F02C 7/042; F01D 15/10; F02C 6/14; F04D 29/563; H02K 7/1823; F05D 2220/32; F05D 2240/35

(57) ABSTRACT

A gas turbine combined electric power generation apparatus includes a gas turbine, a generator performing electric power generation with a driving force of the turbine, a first control device controlling an output of the gas turbine, a frequency converter converting a frequency of electric power supplied from the gas turbine to an external system, a second control device controlling torque of the gas turbine, an electric power supply device other than the gas turbine, a third control device controlling electric power supplied from the electric power supply device to the external system, and a fourth control device distributing an output command to the first control device, the second control device, and the third control device.

### TECHNICAL FIELD

The present invention relates to a gas turbine combined electric power generation apparatus that follows fluctuating electric power at a high speed by a combination of a gas turbine generator and an electric power storage device.

### BACKGROUND ART

The spread of renewable energy such as wind electric power generation and photovoltaic electric power generation is raising concerns over the instability of electric power systems as a whole attributable to fluctuations of their electric power generation outputs. In this regard, load leveling based on a change in output of an existing thermal electric power generator is required. In the thermal electric power generator, gas turbine electric power generation has a shorter start-up time and provides a higher rate of load change than coal-fired electric power generation, and thus is expected to be capable of leveling a renewable energy output fluctuation.

Two-shaft gas turbines have been disclosed as a technique related to a gas turbine driving a generator and the like. Disclosed in PTL 1, for example, is a two-shaft gas turbine including two rotary shafts, one connecting a high-pressure turbine driven by combustion gas generated by a combustor and a compressor sending compressed air to the combustor to each other and the other connecting a low-pressure turbine driven by the combustion gas driving the high-pressure turbine and a load such as a generator to each other.

A change in gas turbine generator output is usually on a minute basis and cannot follow a load change on a second basis of photovoltaic electric power generation and the like. Proposed in this regard is an apparatus and a control for combining an electric power storage device with a gas turbine generator.

A microgrid in which a distributed electric power source and a high-performance secondary battery are combined with each other is disclosed in PTL 2.

A method for using two types of batteries, one being a power-type battery and the other being an energy-type battery, in a distributed electric power source in which photovoltaic electric power generation and a gas turbine generator are combined with each other is disclosed in PTL 3.

### CITATION LIST

### Patent Literature

PTL 1: JP-A-2010-65636

PTL 2: JP-A-2007-159225

PTL 3: JP-A-2004-64814

### SUMMARY OF INVENTION

### Technical Problem

A generator or an electric power storage device is required to be subjected to a high-speed output change for electric power leveling. Alternatively, in a case where the plurality of leveling means are used at the same time, cooperative control needs to be performed. In the gas turbine generator that is disclosed in PTL 1, the output can be changed relatively fast compared to thermal electric power generators, but what is changed for one minute is approximately 10% of a rated output and an output change on a second basis is impossible. Accordingly, a secondary battery such as a lead battery and a lithium battery is required for the leveling of a change that has a shorter cycle. A system according to PTL 2 has been disclosed in this context. The secondary battery, however, has problems because the secondary battery is costly and requires a large installation area due to its low energy density. The secondary battery is also problematic in that its service life is so short that it is not suitable for use for decades such as electric power use. Furthermore, different types of secondary batteries have different characteristics with regard to charging and discharging electric power and stored electric power amounts (time integration of electric power, that is, energy). In a general lead battery for industrial use, for example, discharging electric power is approximately half of charging electric power, and thus a capacity double the battery required for the charging electric power is required when the discharging electric power is a reference. In addition, a high output-type lithium-ion battery is too costly to be used for the storage of a large amount of energy as in the electric power use.

Disclosed in PTL 3 in this regard is a method for combining two types of batteries with each other, one being a power-type battery (excellent in instant high output) and the other being an energy-type battery (that is, one excellent in long-time output). However, a dramatic cost reduction is impossible when a costly power-type lithium-ion battery is used.

The present invention has been made in view of the above-described circumstances, and an object thereof is to provide a gas turbine combined electric power generation apparatus suitable for load leveling.

### Solution to Problem

In order to achieve the above-described object, a gas turbine combined electric power generation apparatus according to the present invention includes a gas turbine, a generator performing electric power generation with a driving force of the turbine, a first control device controlling an output of the gas turbine, a frequency converter converting a frequency of electric power supplied from the gas turbine to an external system, a second control device controlling torque of the gas turbine, an electric power supply device other than the gas turbine, a third control device controlling electric power supplied from the electric power supply device to the external system, and a fourth control device distributing an output command to the first control device, the second control device, and the third control device.

### Advantageous Effects of Invention

According to the present invention, a gas turbine combined electric power generation apparatus suitable for load leveling can be provided.

### BRIEF DESCRIPTION OF DRAWINGS

FIG. 1 is an example of a configuration diagram of a gas turbine electric power generation combined apparatus according to the present invention.

FIG. 2 is an example of commands given to respective combined devices according to the present invention.

FIG. 3 is a block diagram of a motor control.

FIG. 4 is a diagram illustrating an operation of the present invention.

FIG. 5 is a second example of the present invention.

FIG. 6 is a third example of the present invention.

### DESCRIPTION OF EMBODIMENTS

Hereinafter, examples will be described with reference to drawings.

### Example 1

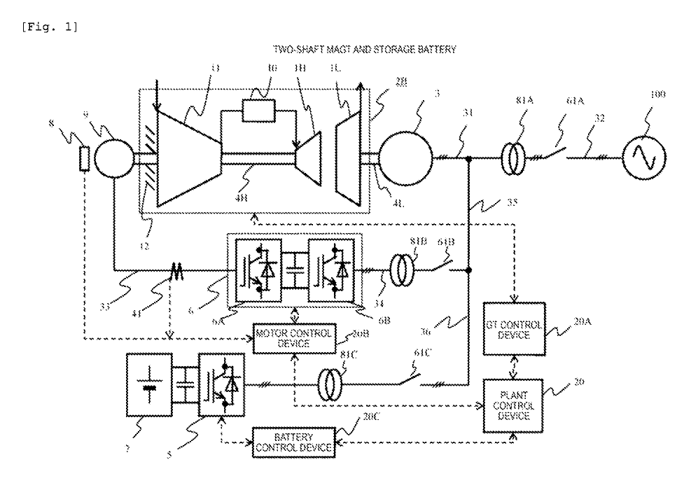

FIG. 1 is a diagram schematically illustrating an overall configuration of a gas turbine combined electric power generation system according to this embodiment. According to FIG. 1, the two-shaft gas turbine electric power generation system according to this embodiment is schematically provided with a two-shaft gas turbine 2B, a synchronous generator 3 that is driven by the two-shaft gas turbine 2B, an electric motor 9 that is connected to the two-shaft gas turbine 2B, a frequency converter 6 that converts a frequency of electric power of the electric motor 9, and a secondary battery 7 that is electrically connected in parallel to the synchronous generator 3 and the frequency converter 6.

The synchronous generator 3 is connected to a system. 100 from an electric power transmission path 31 via a transformer 81A that converts a voltage and a breaker 61A that is disposed so that electric power transmission can be blocked. The electric motor 9 is connected to the electric power transmission path 31 from an electric power transmission path 35 via an electric power transmission path 33, the frequency converter 6, an electric power transmission path 34, a transformer 81B, and a breaker 61B. An electric power transmission path 36 is in parallel to the electric power transmission path 34 and the secondary battery 7 is connected to an electric power converter 5, a transformer 81C, and a breaker 61C on a path thereof.

The two-shaft gas turbine 2B is provided with a compressor 11 that generates compressed air by pressurizing air which is taken in (outside air), a combustor 10 that mixes and burns the compressed air and a fuel, a high-pressure turbine 1H that is driven by combustion gas which is obtained by the combustor 10, a first rotary shaft 4H that connects the compressor 11 and the high-pressure turbine 1H to each other, a low-pressure turbine 1L that is driven by the combustion gas following the driving of the high-pressure turbine 1H, and a second rotary shaft 4L that is connected to the low-pressure turbine 1L.

A gas turbine control device 20A controls the two-shaft gas turbine 2B. The gas turbine control device 20A adjusts a rotation speed of the first rotary shaft 4H and an output of the second rotary shaft 4L by controlling an opening and closing angle of an inlet guide vane 12 (IGV), which is a flow rate adjustment valve disposed at an air intake port of the compressor 11, and an injection fuel of the combustor 10. Mainly, the output is controlled with a fuel quantity and a rotation speed of the high-pressure turbine 11 is controlled by the inlet guide vane 12. The gas turbine control device 20A receives a gas turbine combustion temperature, the rotation speed of the first rotary shaft 4H, and a rotation speed of the second rotary shaft 4L and uses the gas turbine combustion temperature and the rotation speeds for the control. The high-pressure turbine 11 is a site that has a highest temperature because a vane thereof receives high-temperature gas generated from the combustor 10. Efficiency of the gas turbine increases as the temperature increases, and an upper limit of the efficiency is determined by a temperature constraint at that part. Accordingly, the control is usually performed such that a limit temperature is reached.

The synchronous generator 3 is mechanically connected, not via a gear, to the second rotary shaft 4L, which is an output shaft of the low-pressure turbine 1L of the two-shaft gas turbine 2B. A rotation speed of the synchronous generator 3 is synchronized with a frequency of the external system 100, and thus the rotation speed of the synchronous generator 3 is constant at all times and the number of revolutions of the low-pressure turbine 1L is constant as well. Since the rotation speed of the synchronous generator is constant, a torque is changed for an increase or decrease in electric power output. This torque is obtained from the low-pressure turbine 1L. Accordingly, the gas turbine control device 20A determines an output of the synchronous generator.

In a gas turbine according to the related art, a rotation speed of a first rotary shaft is determined with a balance between a rotational force of the high-pressure turbine 1H and power for driving the compressor 11. The rotational force of the high-pressure turbine 1H as the former is substantially determined by a fuel input quantity. The power for driving the compressor as the latter is determined by a flow rate of air compressed by a compressor and an air flow rate of the compressor 11 can be regulated by the inlet guide vane 12 being controlled. In this manner, the balance of the power transmitted to the high-pressure turbine 1H and the low-pressure turbine 1L can be changed. This power ratio is approximately 1:1 in general gas turbines.

In this example, a control parameter of the first rotary shaft can be increased by the electric motor 9 being connected to the first rotary shaft 4H. The first rotary shaft 4H and the electric motor 9 are mechanically connected not via a gear. Main power driving the compressor of the first rotary shaft can be obtained from the high-pressure turbine 1H, and thus the electric motor 9 may have only to regulate the power balance of the high-pressure turbine 1H and the low-pressure turbine 1L. The power balance regulation is performed in the case of, for example, a high environmental temperature. In the gas turbine according to the related art, a density of air entering the compressor is low at a high intake air temperature, and thus the fuel quantity should be reduced for an air-fuel ratio to become constant. According to this example, however, the electric motor 9 assists in the compressor power, and thus an air mass can be increased and a fuel input can be increased. The air density changes by approximately 15% as the temperature changes from 0 [symbol] to 50 [symbol] . The power of the compressor may be adjusted by 15% for an air quantity adjustment of 15%. Accordingly, the power that is required to be assisted by the electric motor 9 is approximately 15% of a gas turbine output. Half of the capacity may be sufficient at a design temperature of 25 [symbol] . Accordingly, a capacity of the electric motor 9 equivalent to, for example, 1/10 is used.

This electric motor 9 is an AC electric motor and is driven with a variable speed depending on an AC frequency. A frequency that a motor control device 20B gives to the frequency converter 6 is variable. This rotation speed is fed back to the motor control device 20B by a speed sensor 8.

The frequency converter 6 is made up of an inverter 6A on the electric motor side and an inverter 6B on the system side, which are connected by a direct current therebetween. The speed of the electric motor 9 can be changed by an AC frequency of the inverter 6A being changed. An alternating current of the inverter 6B is in synchronization with an alternating current of the system 100 at all times. The rotation speed of the electric motor 9 changes as a torque control is exerted by the motor control device 20B, and rotational inertial energy equivalent to the amount by which the speed changes comes in and out of the frequency converter 6. The torque control will be described later.

The secondary battery 7 causes energy to come in and out with a direct current. This direct current is converted to an alternating current by the electric power converter 5. This alternating current is synchronized with the system 100. A battery control device 20C controls the electric power converter 5, causes the AC frequency and a phase to be in accordance with a frequency and a phase of the synchronous generator 3, and inputs and outputs battery energy. In addition, the battery control device 20C monitors a charging rate of the secondary battery 7. The secondary battery 7 responds to a rapid input and output command that the gas turbine cannot respond to and follows a load change as a system combined with gas turbine electric power generation.

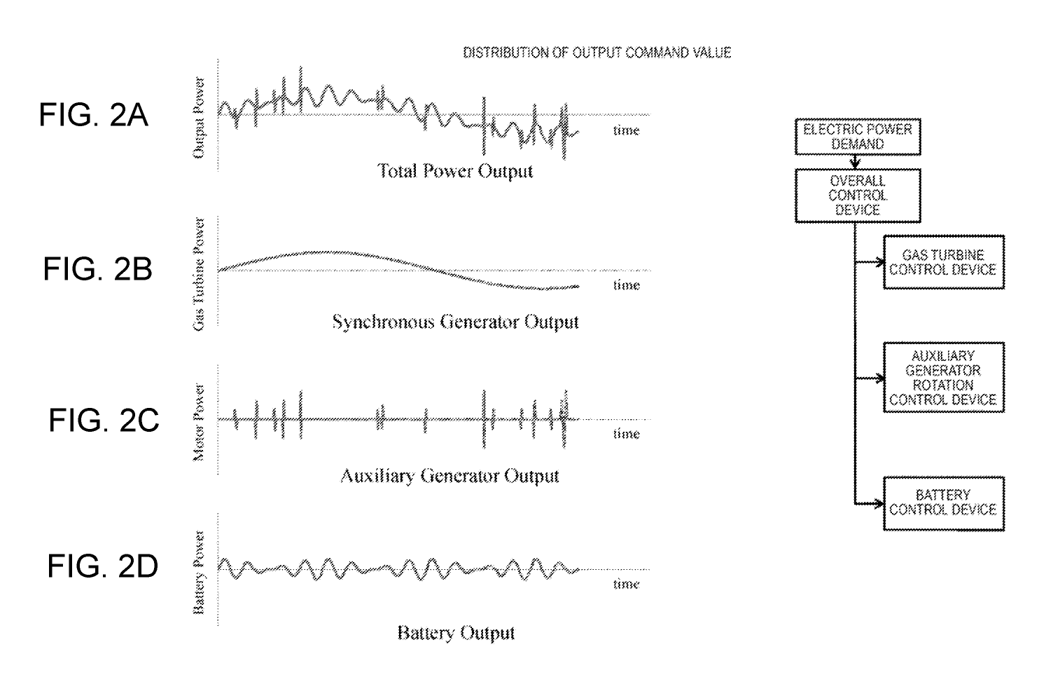

A method for operating the gas turbine system that has the configuration described above will be described below with reference to FIG. 2. A plant control device 20 distributes and sends an electric power command for the entire gas turbine system to three control devices, one being the gas turbine control device 20A, another being the motor control device 20B, and the other being the battery control device 20C. Assuming an electric power generation command for the entire gas turbine system that is illustrated in FIG. 2 (a), for example, a command in FIG. 2(b) is given to the gas turbine control device 20A with respect to a change that is a latest in time, an electric power command in FIG. 2(c) that is an earliest output change amount is given to the motor control device 20B, and an electric power command in FIG. 2 (d) that is equivalent to an intermediate speed change is given to the battery control device 20C. Respective time cycles substantially have an order of at least tens of seconds for the gas turbine control, several seconds or less for the motor control, and several seconds to tens of seconds for the battery control.

With regard to the control of the gas turbine, a rapid output change command cannot be responded to because the amount of working gas in the gas turbine is huge and a buffer thereof is present. For example, a load change speed of the general gas turbines is approximately 10% of a rated output per minute. Accordingly, a command gradual in change speed is given to the gas turbine control device 20A.

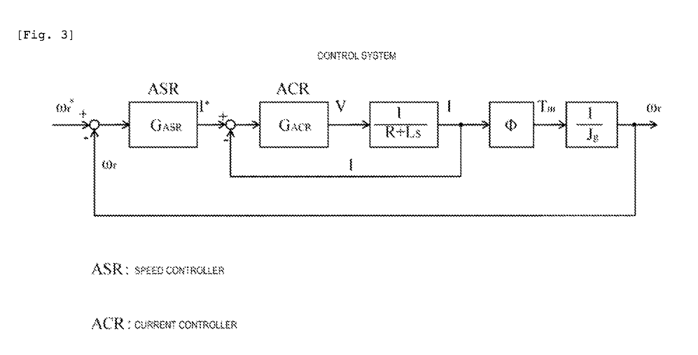

With regard to the motor control, the rotational inertial energy that the first rotary shaft 4H has can be taken out by the electric motor 9 being operated with a variable speed. A block diagram of a motor control system in the motor control device 20B is illustrated in FIG. 3. A current I measured by a current sensor 41 in FIG. 1 is subjected to a feedback control by a current controller ACR. The current can be linearly converted to a magnetic flux and torque, and thus this becomes a torque control. A torque control response is determined by an electrical time constant and is a millisecond order in general, and is sufficiently fast to the point of being ignorable in comparison to a normal gas turbine output change. The speed measured by the rotation sensor 8 of the electric motor is subjected to a feedback control by the speed controller ACR outside a current loop system.

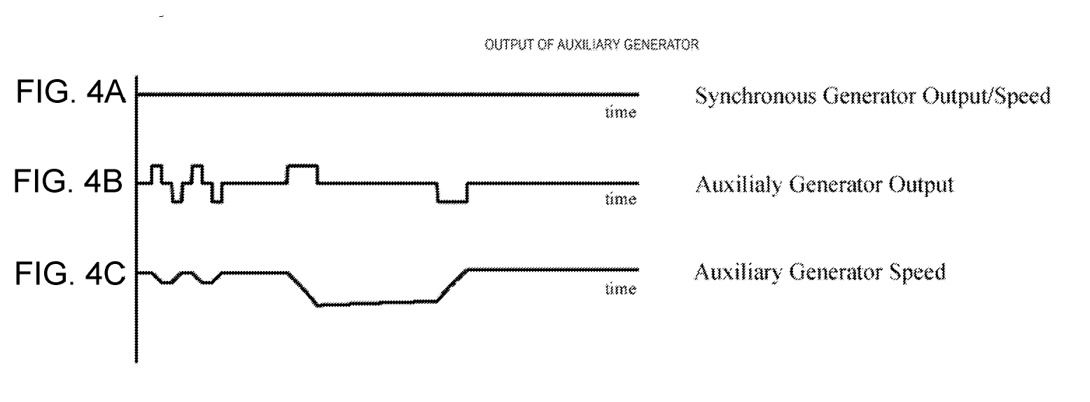

FIG. 4 shows a behavior of the gas turbine 2B. As illustrated in FIG. 4(a), the output and the rotation speed of the low-pressure turbine 4L of the second shaft, that is, the output and the rotation speed of the synchronous generator 3 are constant. For an auxiliary generator to produce an output that changes in a step shape as in FIG. 4(b), a torque command substantially the same in shape as FIG. 4(b) may be produced for the auxiliary generator. The output is “torque [symbol] rotation speed”, and thus an output command can be converted to a sequential torque from the rotation speed fed back from the rotation sensor 8. As described above, the torque response is fast to the point of being ignorable, and thus the output can instantly come in and out as well. An energy source of this output is the rotational inertial energy of the first shaft. Accordingly, an output from the auxiliary generator causes the rotation speed of the first shaft to fall and an input causes the rotation speed to rise as illustrated in FIG. 4 (c). A speed of an auxiliary rotary machine gradually returns when no input and output are performed.

At this time, a rotation speed control is performed in the electric motor 9, and thus the gas turbine control device 20A does not change an opening and closing command for the inlet guide vane 12 for the rotation speed control and has a fixed constant value. In this manner, the motor control is stabilized.

The inertial energy that is taken out by the motor control device 20B is proportional to a total moment of inertia of the compressor 11 and the high-pressure turbine 1H is proportional to a square of the rotation speed. The rotation speed of the compressor is usually as high as 5,000 to 40,000 rpm, and thus has an inertial energy of several kWh. The compressor 11 has a limited operation speed range due to a problem such as surge and, in some cases, a decline from a rated speed is approximately 10 to 20% at best. Time during which the output is taken out from the auxiliary generator is a duration in which the rotation speed of the compressor changes within an allowable range and is an order of approximately several seconds when converted from the energy quantity and the output.

The gas turbine output can be regarded as being constant while the auxiliary generator is in operation given that an output response of the gas turbine is delayed and the time during which the rotation speed of the compressor changes is several seconds as described above.

A reduction in the rotation speed of the compressor that is attributable to energy release by the electric motor 9 results in a reduction in the air flow rate, and thus the combustion temperature rises once the same fuel is input. The rise in the combustion temperature at this time might lead to damage to the high-pressure turbine 1H. Accordingly, in the case of a rapid control using the electric motor 9, an operation at a suppressed fuel input quantity and a low combustion temperature is required. A more efficient operation can be performed based on cooperation between the gas turbine inertial force control and the combustion temperature control as described above.

An electric power storage function using inertial energy is similar in principle to a flywheel. In this example, however, the inertia of the gas turbine is used and no additional equipment such as a flywheel has to be added. Accordingly, a steady loss of an additional device can be ignored.

Next, with respect to an output change that has a cycle of approximately tens of seconds, which cannot be followed by the gas turbine control and is not satisfied by the inertial energy of the auxiliary generator, the energy is compensated for by the secondary battery. In this case, a rapid large output is compensated for with the motor control described above, and thus an output command that is to be burdened by the secondary battery 7 becomes gentle. Accordingly, a capacity of the secondary battery and a capacity of the electric power converter 5 can be reduced. In a case where the secondary battery 9 is a lead battery, for example, instant large output production is impossible, and thus a large number of batteries are required. According to this example, however, the instant output is compensated for by the motor control by the use of the inertial energy of the first rotary shaft 4H, and thus the output that is required for the secondary battery is reduced to the same extent. In this manner, a battery mounting quantity and the capacity of the electric power converter 5 can be reduced.

The required secondary battery mounting quantity is determined from both the output and the energy. Although a large amount of energy needs to be stored for use for electric power use, a lead battery and an NAS battery that are the lowest in cost per energy are not good at instant large output production, and thus are not suitable for short-cycle fluctuation absorption. An increase in parallel number is required and the number of the batteries required exceeds required energy for such batteries to be used for the short-period fluctuation absorption. A lithium battery and a nickel-hydrogen battery are suitable for an instant large output but are costly. It is economical to obtain the large output by several seconds as in this example from the auxiliary generator instead of a battery. In addition, the output change of at least tens of seconds as in FIG. 2 (b) may be compensated for by the gas turbine output. As described above, in this example, the triple control of the gas turbine output control, the gas turbine inertial force control, and the control of the electric power from the secondary battery as an electric power supply device are combined with one another, and thus the required secondary battery quantity can be reduced. Maximum electric power that is required for the secondary battery can be suppressed and stored energy can also be reduced insofar as distribution of this triple control is appropriately determined in accordance with a rate of change in output command. As a result, a secondary battery capacity for fluctuation absorption can be reduced.

When the secondary battery 7 has a high charging rate, the secondary battery has room in discharge capacity and has no room in absorption capacity. In this regard, the energy stored in the first shaft 4H of the gas turbine is reduced and the electric power that can be absorbed on this side is increased. Specifically, the rotation speed is controlled at a low level. In a case where the secondary battery 7 has a low charging rate, in contrast, the rotation speed of the first shaft is controlled at a high level. This cooperative control is also performed by the plant control device 20.

An extended service life of the secondary battery 7 can also be anticipated as an effect of this example. The service lives of secondary batteries are shortened by damage attributable to rapid charging and discharging. By the motor control being combined as described above, however, the rapid charging and discharging of the secondary battery can be alleviated.

Another effect of this example is a merit of low additional equipment cost. This is because the auxiliary generator and the auxiliary generator-driving frequency converter may be half or less in capacity compared to the synchronous generator. In general, large-capacity frequency converters for electric power use and the like are large in volume and costlier than rotating electrical machines. In the system that is disclosed in PTL 3, for example, the frequency converter requires capacity as is the gas turbine because the electric power of the gas turbine generator is temporarily converted to a direct current. According to this example, however, the main electric power-supplying generator 3 is an AC generator driven on a system frequency, and thus requires no frequency converter. Because a frequency converter that drives the auxiliary electric motor 9 small in capacity and responding to an output fluctuation will suffice, costs can be reduced based on a decrease in frequency converter capacity and an electrical loss thereof can be suppressed as well.

Another effect of this example is an increase in apparatus reliability. This is because the electric motor 9 and the first rotary shaft 4H are configured to be connected not via a gear and wear and deterioration can be prevented that are attributable to noise and an impact caused by a change in surface abutting directions of speed reducer teeth with respect to reverse torque acting when the electric motor 9 switches from charging to electric power generation.

In the two-shaft gas turbine according to this example, nothing but a structure of the low-pressure turbine 1L should be changed for 50 Hz/60 Hz response and the speed of the second rotary shaft can have a configuration in which the synchronous generator 3 and the second rotary shaft 4L are connected not via the gear, and thus a speed reducer for 50 Hz/60 Hz response can be omitted for loss and cost reduction. Example 1 described above is a gas turbine combined electric power generation apparatus including the gas turbine 2B, the synchronous generator 3, which is a generator connected to the second rotary shaft 4L and performing electric power generation with a driving force of the low-pressure turbine 1L, the GT control device 20A, which is a first control device controlling the output of the gas turbine 2B, the electric motor 9 connected to the first rotary shaft 4H and adjusting the power balance between the first rotary shaft 4H and the second rotary shaft 4L, the electric power transmission paths 31 and 32 connecting the generator and the external system 100, the first frequency converter 6 converting the frequency of the electric power supplied to the external system 100 between the electric power transmission paths 31 and 32 and the electric motor 9, the motor control device 20B, which is a second control device controlling the torque of the gas turbine 2B by controlling the electric motor 9, the secondary battery 7 disposed on a path parallel to the electric power transmission paths 31 and 32, the electric power converter 5, which is a second frequency converter converting the frequency of the electric power supplied from the secondary battery 7 to the external system 100, the battery control device 20C, which is a third control device controlling the electric power supplied from the secondary battery 7 to the external system 100, and the plant control device 20, which is a fourth control device distributing the output command to the GT control device 20A, the motor control device 20B, and the battery control device 20C.

In this gas turbine combined electric power generation apparatus, the GT control device 20A controls the output of the gas turbine 2B by controlling the inlet guide vane 12, the motor control device 20B controls the torque of the gas turbine 2B by controlling the number of revolutions of the electric motor 9 via the first frequency converter 6, and the battery control device 20C controls the electric power from the secondary battery 7 via the electric power converter 5 as the second frequency converter. Accordingly, in the gas turbine combined electric power generation apparatus, the maximum electric power that is required for the secondary battery can be suppressed and the stored energy can also be reduced. As a result, the capacity of the secondary battery for fluctuation absorption can be reduced.

### Example 2

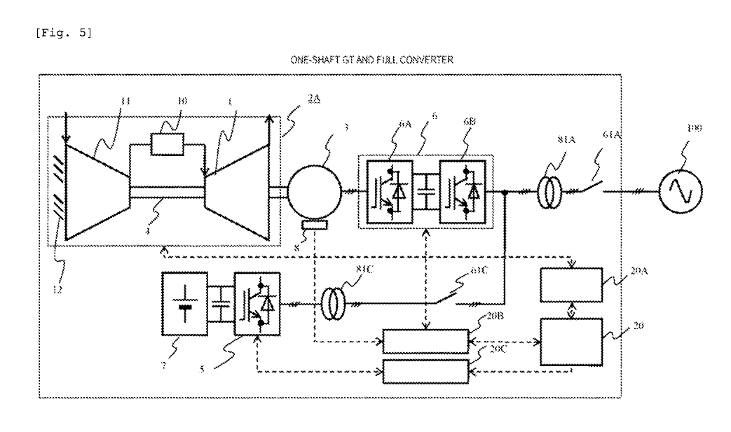

FIG. 5 is a diagram schematically illustrating an overall configuration of a gas turbine combined electric power generation apparatus according to another example of the present invention. Description of devices similar to those in FIG. 1 will be omitted.

A gas turbine 2A is a one-shaft gas turbine unlike in the first example. The combustion gas released from the combustor 10 is received by the turbine 1 and an output is given to the synchronous electric motor 3 by power thereof being used. The shaft of the synchronous generator 3 and a shaft 4 of the turbine 1 correspond to each other. The synchronous electric motor 3 supplies electric power to the system via the frequency converter 6 unlike in the first example. The synchronous electric motor 3 may have a variable rotation speed and AC electric power thereof is converted to a direct current at all times by a frequency converter 6A. This DC electric power is converted by the inverter of a frequency converter 6B for synchronization between the frequency and the phase of the system.

In a steady state of the gas turbine 2A, the output of the gas turbine 2A and the output of the synchronous generator 3 are equal to each other if the loss of the synchronous generator 3 is ignored. The output of the synchronous generator 3 is “torque [symbol] rotation speed”, and thus a ratio of the torque and the rotation speed of the synchronous electric motor 3 can be changed even at the same gas turbine output. Transiently, however, the inertial energy of the rotary shaft 4 to which the synchronous electric motor 3 is connected changes by the amount of the change in speed. Accordingly, energy can come in and out during the time in which the synchronous electric motor 3 is subjected to a variable speed control. Its effect is the same as that of the first example. In other words, the inertial energy can come in and out by the torque of the synchronous electric motor 3 being controlled and the rotation speed being changed by the motor control device 20B. At this time, the rotation speed can be read by the speed sensor 8 and fed back to the motor control device 20B and electric power calculation can be performed by the rotation speed and the inertia being used, and thus this can be controlled. This is separate from the output of the synchronous generator 3. A steady output of the synchronous generator 3 substantially corresponds to the output of the gas turbine and is controlled by the gas turbine control device 20A as described in Example 1.

The gas turbine electric power generation combined apparatus that is provided with this gas turbine generator and the secondary battery 7 distributes the output command to three as in Example 1 and performs cooperative control on the respective ones. Then, a combined electric power generation apparatus that is capable of high-speed response can be obtained.

Example 2 described above is a gas turbine combined electric power generation apparatus including the gas turbine 2A, the synchronous generator 3, which is a generator performing electric power generation with a driving force of the turbine 1, the gas turbine control device 20A, which is a first control device controlling the output of the gas turbine 2A, the electric power transmission path connecting the synchronous generator 3 and the external system, the frequency converter 6 disposed on the electric power transmission path and converting the frequency of the electric power supplied to the external system from the gas turbine 2A, the motor control device 20B, which is a second control device controlling the torque of the gas turbine, the secondary battery 7 disposed on a path parallel to the electric power transmission path, the electric power converter 5, which is a second frequency converter converting the frequency of the electric power supplied from the secondary battery 7 to the external system, the battery control device 20C, which is a third control device controlling the electric power supplied from the secondary battery 7 to the external system, and the plant control device 20, which is a fourth control device distributing the output command to the GT control device 20A, the motor control device 20B, and the battery control device 20C.

This gas turbine combined electric power generation apparatus variably controls the rotation speed of the generator 3 by the motor control device 20B as the second control device giving the command to the frequency converter 6 and has a calculation function for calculating the amount of the rotation speed change as the inertial energy of the rotary shaft. Because of this control, the inertial energy can be effectively used for load leveling despite the one-shaft gas turbine.

### Example 3

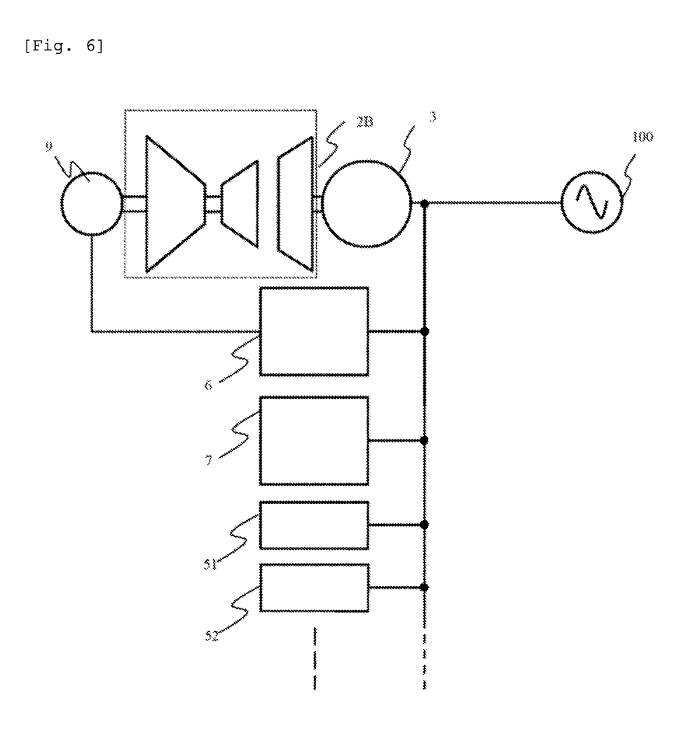

FIG. 6 shows another example of the present invention. Although the two-shaft gas turbine, the frequency converter, and the secondary battery constitute the configuration that is illustrated in FIG. 1, distributed electric power source devices 51 and 52 that are connected in parallel to the secondary battery may be added thereto. The gas turbine generator according to this example that is separately provided, a normal gas turbine generator, a combustion-type generator using a diesel engine, a gas engine, or the like, or any one of a wind generator, a photovoltaic electric power generation device, a solar electric power generation device, a hydroelectric generator, a secondary battery with different characteristics, and the like can be used as the distributed electric power source device. In this case, effects similar to those of Examples 1 and 2 can be achieved insofar as an electric power generation amount of each distributed electric power source device is measured, a difference from an overall output command is used an output command value, and cooperative control is performed for compensation with the output of the device described in Examples 1 and 2.

The gas turbine combined electric power generation apparatus according to each example described above includes the gas turbine, the generator performing electric power generation with the driving force of the turbine, the first control device controlling the output of the gas turbine, the frequency converter converting the frequency of the electric power supplied from the gas turbine to the external system, the second control device controlling the torque of the gas turbine, the electric power supply device other than the gas turbine, the third control device controlling the electric power supplied from the electric power supply device to the external system, and the fourth control device distributing the output command to the first control device, the second control device, and the third control device. Accordingly, the gas turbine combined electric power generation apparatus according to each example described above has a high level of load following property and is a simple-facility apparatus suitable for load leveling.

### REFERENCE SIGNS LIST

1 Turbine
2A One-shaft gas turbine
2B Two-shaft gas turbine
3 Generator
4 Gas turbine shaft
4H High-pressure shaft of two-shaft gas turbine
4L Low-pressure shaft of two-shaft gas turbine
5 Converter for secondary battery
6 Frequency converter
7 Secondary battery
8 Rotation sensor
9 Electric motor
10 Combustor
11 Compressor
12 Inlet guide vane
20 Controller for entire electric power generation system
20A Gas turbine controller
20B Motor-generator controller
20C Battery controller
31 to 36 Electric power transmission path
41 Current sensor
51 Photovoltaic electric power generation, wind electric power generation and the like
52 Another electric power source (such as diesel generator)
61A System breaker
61B Converter breaker for motor
61C Breaker for battery
81A System transformer
81B Transformer for motor
81C Transformer for battery
100 System

1. A gas turbine combined electric power generation apparatus comprising:
a gas turbine including a compressor generating compressed air by pressurizing air, a combustor mixing and burning the compressed air and a fuel, and a turbine driven by combustion gas obtained by the combustor;
A generator performing electric power generation with a driving force of the turbine;
A first control device controlling an output of the gas turbine;
a frequency converter converting a frequency of electric power supplied from the gas turbine to an external system;
a second control device controlling torque of the gas turbine;
an electric power supply device other than the gas turbine;
a third control device controlling electric power supplied from the electric power supply device to the external system; and
a fourth control device distributing an output command to the first control device, the second control device, and the third control device.

2. A gas turbine combined electric power generation apparatus according to claim 1 comprising:
a gas turbine including a compressor generating compressed air by pressurizing air, a combustor mixing and burning the compressed air and a fuel, a high-pressure turbine driven by combustion gas obtained by the combustor, a first rotary shaft connecting the compressor and the high-pressure turbine to each other, a low-pressure turbine driven by the combustion gas driving the high-pressure turbine, and a second rotary shaft as a rotary shaft of the low-pressure turbine and including an inlet guide vane disposed at an air intake port of the compressor;
a generator connected to the second rotary shaft and performing electric power generation with a driving force of the low-pressure turbine;
a first control device controlling an output of the gas turbine;
an electric motor connected to the first rotary shaft and adjusting a power balance between the first rotary shaft and the second rotary shaft;
an electric power transmission path connecting the generator and an external system to each other;
a first frequency converter converting a frequency of electric power supplied to the external system between the electric power transmission path and the electric motor;
a second control device controlling torque of the gas turbine by controlling the electric motor;
a secondary battery disposed on a path parallel to the electric power transmission path;
a second frequency converter converting a frequency of electric power supplied from the secondary battery to the external system;
a third control device controlling the electric power supplied from the secondary battery to the external system; and
a fourth control device distributing an output command to the first control device, the second control device, and the third control device.

3. The gas turbine combined electric power generation apparatus according to claim 2,
wherein the first control device controls the output of the gas turbine by controlling the inlet guide vane,
wherein the second control device controls the torque of the gas turbine by controlling the number of revolutions of the electric motor via the first frequency converter, and
wherein the third control device controls the electric power from the secondary battery via the second frequency converter.

4. The gas turbine combined electric power generation apparatus according to claim 2,
wherein the generator is a synchronous generator.

5. The gas turbine combined electric power generation apparatus according to claim 2,
wherein a capacity of the electric motor is ½ or less of a capacity of the generator.

6. The gas turbine combined electric power generation apparatus according to claim 2,
wherein the electric motor is mechanically connected to the compressor not via a gear.

7. A gas turbine combined electric power generation apparatus according to claim 1 comprising:
a gas turbine including a compressor generating compressed air by pressurizing air, a combustor mixing and burning the compressed air and a fuel, a turbine connected to the same rotary shaft as the compressor and driven by combustion gas obtained by the combustor, and an inlet guide vane disposed at an air intake port of the compressor;
a generator performing electric power generation with a driving force of the turbine;
a first control device controlling an output of the gas turbine;
an electric power transmission path connecting the generator and an external system to each other;
a frequency converter disposed on the electric power transmission path and converting a frequency of electric power supplied from the gas turbine to the external system;
a second control device controlling torque of the gas turbine;
a secondary battery disposed on a path parallel to the electric power transmission path;
a second frequency converter converting a frequency of electric power supplied from the secondary battery to the external system;
a third control device controlling the electric power supplied from the secondary battery to the external system; and
a fourth control device distributing an output command to the first control device, the second control device, and the third control device.

8. The gas turbine combined electric power generation apparatus according to claim 7,
wherein the second control device variably controls a rotation speed of the generator by giving a command to the first frequency converter and has a calculation function for calculating the amount of the rotation speed change as inertial energy of the rotary shaft.

9. The gas turbine combined electric power generation apparatus according to claim 1,
wherein the generator is mechanically connected to the turbine not via a gear.

10. The gas turbine combined electric power generation apparatus according to claim 1 comprising a distributed electric power source device connected in parallel to the electric power supply device.

11. The gas turbine combined electric power generation apparatus according to claim 10,
wherein the fourth control device distributes a difference between an output of the distributed electric power source device and a required output of the entire system to the first control device, the second control device, and the third control device as the output command.

12. The gas turbine combined electric power generation apparatus according to claim 1,
wherein the electric power supply device and the distributed electric power source device are a combustion-type electric power generation device, a wind electric power generation device, a photovoltaic electric power generation device, a solar electric power generation device, a hydroelectric power generation device, or a secondary battery.

13. A control method for a gas turbine combined electric power generation apparatus including a gas turbine having a compressor generating compressed air by pressurizing air, a combustor mixing and burning the compressed air and a fuel, and a turbine driven by combustion gas obtained by the combustor, a generator performing electric power generation with a driving force of the turbine, and an electric power supply device other than the gas turbine, the control method for a gas turbine combined electric power generation apparatus being a combination of three controls, one being an output control for the gas turbine, another being an inertial force control for the gas turbine, and the other being a control of electric power from the electric power supply device.

14. The control method for a gas turbine combined electric power generation apparatus according to claim 13,
wherein distribution of the three controls is determined in accordance with a rate of change in output command.

15. The control method for a gas turbine combined electric power generation apparatus according to claim 13,
wherein the gas turbine output control is carried out by opening and closing of an inlet guide vane of the compressor and the opening and closing of the inlet guide vane is not carried out during the inertial force control for the gas turbine.

16. The control method for a gas turbine combined electric power generation apparatus according to claim 13,
wherein the inertial force control for the gas turbine and a combustion temperature control for the gas turbine are in cooperation with each other.

17. The control method for a gas turbine combined electric power generation apparatus according to claim 13,
wherein the electric power supply device is a secondary battery and a charging rate of the secondary battery and the inertial force control for the gas turbine are emphasized.
